(19) United States
(12) Patent Application Publication
(10) Pub. No.: US 2002/0166805 A1
(43) Pub. Date: Nov. 14, 2002

(54) Filter assembly and method of manufacture

(76) Inventors: Gian D. Minns, Riverview (AU); Michael A. Hawes, Berowra (AU); John H. Oakey, Toongabbie (AU); Ian L. Trew, Letbridge Park (AU); Philip C. Ridgeway, Bega (AU)

Correspondence Address: Cummings & Lockwood, 700 State Street, P.O. Box 1960, New Haven, CT, 06509-1960, US

(21) Appl. No.: 10/103,071

(22) Filed: Mar. 21, 2002

Related U.S. Application Data
(60) Provisional application No. 60/277,726, filed on Mar. 21, 2001.

(51) Int. Cl. B01D 35/30; B29C 45/00

(52) U.S. Cl. 210/232; 210/322; 264/328.1

(57) ABSTRACT

A filtration assembly and method of making the same is disclosed. More specifically disclose herein are filter head and cartridge configurations which create custom-fit replacement filter assemblies, have an improved receptacle/lug configuration and are capable of being manufactured exclusively by the injection molding process. The filter head includes a plurality of engagement areas for receiving the cartridge housing lugs. A portion of each engagement area is formed by inserting downwardly projecting blades into the mold assembly which forms the filter head by injection molding.

### CROSS-REFERENCE TO RELATED APPLICATION

This application claims priority to U.S. Provisional Patent Application Serial No. 60/277,726, filed Mar. 21, 2001, and is related to commonly assigned U.S. patent application Ser. No. 09/553,982, filed Apr. 20, 2000, the disclosures of which are herein incorporated by reference in their entirety to the extent that they do not conflict with the present disclosure.

### BACKGROUND OF THE INVENTION

1. Field of the Invention

The subject disclosure relates to filtration assemblies, and more specifically to: a method of manufacturing filter heads for the filtration assemblies; filter head and cartridge configurations which create custom-fit replacement filter assemblies; and a filter assembly having a new receptacle/lug configuration.

2. Background of the Related Art

Often in both consumer and industrial applications a fluid, such as water, is filtered prior to its use in an intended application. As a result, filtration systems are installed either internally or externally within the industrial system or consumer appliance. For example, in today's modern society, refrigerators which provide drinking water and produce ice are widespread. Commonly this type of refrigerator utilizes an internal filtration system for purifying the water used for drinking and ice production. Additionally, since water is the base for many beverages such as soda and coffee, it is also commonplace to find water filtration assemblies installed within or in conjunction with commercial vending machines that dispense coffee or soft drinks.

Like most filtration systems, frequent replacement of the filter media within the cartridge is required for commercial and consumer filtration. Therefore, these filtration assemblies are typically equipped with filter cartridges which can be easily disengaged from a filter head, discarded and replaced, without requiring the removal of the remaining components of the filter system. Examples of prior art filter assemblies having replaceable filter cartridges are disclosed in commonly assigned U.S. Pat. No. 4,735,716 to Petrucci et al. and U.S. Pat. No. 4,806,240 to Giordano et al.

In filtration systems that have a replaceable cartridge, the cartridge housing is provided with a set of cam lugs which depend radially outwardly therefrom and are configured to rotatably engage with corresponding receptacles formed in the filter head, thereby securing the filter cartridge to the filter head. Examples of prior art filter cartridges having lugged engagement portions are disclosed in Petrucci et al. and Giordano et al. referred to hereinabove, and in U.S. Pat. Nos. 4,857,189 and 4,956,086 to Thomsen et al.

A disadvantage associated with prior art filter heads having receptacles adapted and configured for engaging with corresponding lugs formed in the filter cartridges is that they are expensive to manufacture. These filter heads are primarily manufactured by an injection molding process. However, in order to form the receptacle feature, which is located on the underside of the filter head, complex tooling must be used in conjunction with the injection molding process. Traditionally, this complex tooling uses collapsing or rotating cores to form the receptacles. Equipment of this type is often mechanically unreliable, requires frequent maintenance and is costly. If a filter head can be manufactured exclusively by the injection molding process, without the use of complex, unreliable tooling, the associated manufacturing cost can be reduced.

Still further, in most instances, replaceable filter cartridges which are employed in industrial and consumer applications are manufactured in accordance with particular design specifications and performance parameters provided by the system designer of equipment manufacturer. In many cases, the filter media used in such systems consists of a proprietary material or is manufactured using a proprietary process. Thus, system designers or equipment manufacturers often recommend that replacement filter cartridges be purchased from the original system or equipment provider so as to ensure the integrity and proper operation of the filtration system.

However, the owner of a household appliance or the maintenance personnel servicing a commercial application is oftentimes not aware of the replacement filter specifications and operating parameters of the filtering system. Consequently, they unknowingly jeopardize the integrity of the filtration system by replacing a used filter cartridge with an inferior or incompatible replacement filter supplied by an after-market manufacturer. This problem has also been encountered with automotive filters, as inferior replacement fuel filters are frequently installed in a vehicle without the knowledge of the vehicle owner or operator.

One solution to this problem is disclosed in U.S. Pat. No. 5,035,797 to Janik, wherein a key system is used for axially mounted fuel filters with threaded retaining collars to create a custom-fit feature which ensures replacement cartridge compatibility. The key system employs a unique matrix of axially projecting keys formed in a base for axially receiving a filter cartridge, and a corresponding matrix of slots formed in a compatible cartridge. Therefore, for a given compatible cartridge and base, the keys interlock with the slots and secure the cartridge to the base. For each non-compatible cartridge and base, the base keys do not mate with the cartridge slots and the resulting interference prevents the mounting of the cartridge to the base. A similar key system is disclosed in U.S. Pat. No. 5,186,829 to Janik which includes a set of angularly spaced arcuate projections that protrude radially from the cylindrical side wall of the fuel filter cartridge to mate with corresponding spaced apart recesses in the base when the cartridge is axially pushed into the base.

Using a key system to ensure that the replacement filter cartridge is compatible with the filtration system, increases the complexity of the mold for the filter head. In order to create the various key configurations, multiple base molds are required and therefore must be manufactured and installed in the injection molding apparatus, increasing manufacturing cost. If the custom-fit feature provided by the key system can be created without requiring the use of multiple base molds, the manufacturing process will be simplified and the associated cost reduced.

In addition to the above-mentioned manufacturing issues, replacement filters for prior art filtration assemblies can be difficult to install. Prior art filters use a two lug configuration to secure the filter cartridge to the base or head. For a two lug configuration, an angle of rotation of approximately 80° is required to fully engage the replacement filter.

There is a need, therefore, for a new filter head system for use in both industrial or consumer applications which: can be manufactured exclusively by an injection molding process; which provides a custom-fit feature without requiring the use of multiple base molds; and which reduces the amount of rotation required to fully engage the replacement filter.

### SUMMARY OF THE INVENTION

The subject application is directed to filtration assemblies and methods of making the same, and more specifically to filter head and cartridge configurations which create custom-fit replacement filter assemblies, have an improved receptacle/lug configuration and are capable of being manufactured exclusively by the injection molding process.

The subject application is directed to a filter head for use in a filtration assembly which includes a replaceable cartridge housing that contains filter media for conditioning fluid passing therethrough. The cartridge housing has a neck portion and angularly-spaced apart lugs projecting radially outwardly therefrom.

The filter head of the present disclosure includes an upper body portion and a lower body portion. The upper body portion defines an axial bore for receiving the neck portion of the cartridge housing. The lower body portion includes a radially extending web section and a flange section which depending axially from the outer periphery of the web section. The inner surface of the flange section defines a plurality of engagement areas. Each engagement area includes a reception area for axially receiving one of the cartridge housing lugs and a locking recess. The locking recesses are associated with and angularly offset from the reception areas and rotatably receive the cartridge housing lugs. A lower surface of each locking recess is defined by a rib structure which axially secures the cartridge housing to the filter head.

The web section of the lower body portion has apertures formed therein which are radially aligned with and extend over each rib structure. Preferably the apertures are arcuate in shape. In the present embodiment, each locking recess is formed by inserting downwardly projecting blades into the mold assembly which forms the filter head by injection molding.

Preferably, the axial bore of the upper body portion defines first and second sealing surfaces. Additionally, it is envisioned that the upper body portion of the filter head further includes at least one inlet port for receiving fluid into the filter head and at least one outlet port for discharging fluid from the filter head. In this embodiment, the first sealing surface acts to fluidly isolate the inlet port(s) of the upper body portion from the outlet port(s) and the second sealing surface fluidly isolates the inlet port(s) from the apertures formed in the web section of the lower body portion.

The subject disclosure also pertains to a method of manufacturing a filter head. The filter head includes an upper body portion and a lower body portion. The upper body portion defines an axial bore for receiving the neck portion of the cartridge housing. The lower body portion includes a radially extending web section and a flange section which depending axially from the outer periphery of the web section. The inner surface of the flange section defines a plurality of engagement areas. Each engagement area includes a reception area for axially receiving one of the cartridge housing lugs and a locking recess. The locking recesses are associated with and angularly offset from the reception areas and rotatably receive the cartridge housing lugs. A lower surface of each locking recess is defined by a rib structure which axially secures the cartridge housing to the filter head. The web section of the lower body portion has apertures formed therein which are radially aligned with and extend over each rib structure.

The method for manufacturing a filter head disclosed herein includes, inter alia, providing upper and lower base mold portions and injecting a thermoplastic therein. The upper mold portion has a bottom surface that is adapted and configured for defining an upper section of the filter head. This bottom surface has a plurality of blade elements projecting downwardly therefrom.

The lower base mold portion has a top surface and a central post member. The top surface is adapted and configured for defining a lower section of the filter head and the central post defines the axial bore of the filter head.

The disclosed method further includes positioning the bottom surface of the upper base mold portion adjacent to the top surface of lower base mold portion so as to define a mold chamber therebetween. Each blade element of the upper mold portion projects into the mold chamber so as to define each aperture in the web section and each engagement area locking recess. Then the mold chamber is filled with a thermoplastic by injection so as to form the filter head.

The method of manufacturing a filter head further includes the step of positioning a mold insert over the central post of the lower base mold prior to positioning the bottom surface of the upper base mold portion adjacent to the top surface of lower base mold. The mold insert is adapted and configured for defining a portion of the inner surface of the axial bore.

It is presently preferred that the method of manufacturing a filter includes the step of positioning a ring-shaped mold insert adjacent to the top surface of the lower mold portion and concentrically around the central post. This step is accomplished prior to positioning the bottom surface of the upper base mold portion adjacent to the top surface of lower base mold. The mold insert has an upper surface which includes at least one protuberance so as to form a corresponding recess in the web section of the filter head.

In an alternated embodiment, the method of manufacturing a filter head disclosed herein further includes the step of positioning a ring-shaped mold insert adjacent to the top surface of the lower mold portion and concentrically around the central post. Again the is accomplished prior to positioning the bottom surface of the upper base mold portion adjacent to the top surface of lower base mold. The mold insert has an outer surface which includes a plurality of protuberances and is adapted and configured for defining the reception areas of the flange section.

The present disclosure is also directed to a set of interconnecting filter heads and cartridge housings which include a plurality of filter heads and a plurality of corresponding cartridge housings. The plurality of filter cartridge housings each include a body portion and a neck portion depending from and in fluid communication with the body portion. The neck portion defines an upper section with a first outer diameter and a lower section with a second outer diameter. Each housing in the set has at least one of a first outer diameter and a second outer diameter which differs from each of the other housings in the set.

The plurality of filter heads each have an upper sealing surface with a first inner diameter and a lower sealing surface with a second inner. The diameters of these sealing surfaces are dimensioned to sealing correspond with the first and second outer diameters of only one of the plurality of filter cartridge housings in the set.

Preferably, the first outer diameter of the upper neck portion and the second outer diameter of the lower neck portion have a recess formed therein for receiving an O-ring seal. It is also envisioned that each filter head includes an upper body portion and a lower body portion. The upper body portion has the upper and the lower sealing surfaces associated therewith The lower body portion includes a radially extending web section which has a flange section depending from the outer periphery of the web section. The web section has several apertures formed therein.

It is presently envisioned that each cartridge housing in the set further includes at least two lugs depending radially outwardly therefrom and the flange portion of the base has at least two engagement areas formed therein for receiving the lugs of the corresponding cartridge housing and securing the housing thereto.

The present disclosure is also directed to a set of interconnecting filter heads and cartridge housings. The filter cartridge housings each include a body portion and a neck portion depending from and in fluid communication with the body portion. The neck portion defines an upper section with a first outer diameter and a lower section with a second outer diameter. Also each housing has a plurality of cam lugs depending radially outwardly therefrom.

Each filter head in the set has an upper sealing surface with a first inner diameter and a lower sealing surface with a second inner diameter. Each filter head also has several engagement areas formed therein which are adapted and configured for receiving the lugs of the of the cartridge housing.

The set of interconnecting filter heads and cartridge housings further includes a mechanism for ensuring that each filter head is compatible with only one of the plurality of filter cartridge housings in the set. In one embodiment, the mechanism for ensuring that each filter head is compatible with only one of the plurality of filter cartridge housings includes configuring the first inner diameter of the upper sealing surface so that it corresponds with the first outer diameter of only one of the plurality of cartridge housings in the set.

Alternatively, the mechanism for ensuring that each filter head is compatible with only one of the plurality of filter cartridge housings can include configuring the second inner diameter of the lower sealing surface so that it corresponds with the second outer diameter of only one of the plurality of cartridge housings in the set.

In still yet another embodiment the mechanism for ensuring that each filter head is compatible with only one of the plurality of filter cartridge housings includes varying a quantity of the at least two engagement areas so as to correspond with a quantity of the at least two lugs of only one of the plurality of cartridge housings in the set.

Still further the mechanism includes varying the configuration of the engagement areas so as to correspond with the lugs of only one of the plurality of cartridge housings in the set.

Those skilled in the art will readily appreciate that the present disclosure provides filter head and cartridge configurations which create custom-fit replacement filter assemblies, have an improved receptacle/lug configuration and are capable of being manufactured exclusively by the injection molding process These and other unique features of the filtration assembles and method of making the same disclosed herein will become more readily apparent from the following description, the accompanying drawings and the appended claims.

### BRIEF DESCRIPTION OF THE DRAWINGS

So that those having ordinary skill in the art to which the present application appertains will more readily understand how to make and use the same, reference may be had to the drawings wherein:

FIG. 1 is a perspective view of an injection molding apparatus configured in accordance with the present disclosure and having a pair of custom-fit filter heads engaged therewith, the lower half of the mold being separated from the upper half, the upper half including two sets of four blades which form the locking recesses;

FIG. 2 illustrates a cross-sectional view of a filter head configured in accordance with the present disclosure which is capable of being manufactured exclusively by the injection molding process;

FIG. 3 illustrates a perspective view of the bottom of the filter head of FIG. 2, the filter head having four locking recess configured to engage with four corresponding lugs on the filter cartridge;

FIG. 4 is a perspective view of the filter head of FIG. 2 which shows the four arcuate access apertures which are formed in the filter head cover by the blades;

FIG. 5 is a cross-sectional view of a filter cartridge housing with a neck portion having upper and lower section;

FIG. 6 is a cross-sectional view of an interconnected filter head and cartridge housing in which the upper and lower sealing surfaces have diameters which correspond to the upper and lower O-ring grooves;

FIG. 7 illustrates a cross-sectional view of a filter head and cartridge housing in which the upper sealing surface has a diameter which corresponds to the upper O-ring groove, but the lower sealing surfaces has a diameter which is larger than that of the lower O-ring groove;

FIG. 8 illustrates a cross-sectional view of a filter head and cartridge housing in which the lower sealing surface has an inner diameter which is the same as the outer diameter of the O-ring groove, while the upper sealing surface has an inner diameter which is smaller than the outer diameter of the upper O-ring groove causing an interference and preventing installation of an incompatible filter cartridge;

FIGS. 9a-9b illustrate cross-sectional views of two filter assemblies in which the configuration of the lugs and locking recesses are used to provide the custom-fit feature of the subject invention;

FIGS. 10a-10b illustrate cross-sectional views of two filter assemblies in which face keys are used to provide the custom-fit feature of the subject invention, FIG. 14a showing a filter cartridge which is not compatible with the filter head and the FIG. 14b showing a filtration assembly having compatible components;

FIG. 11a illustrates a bottom plan view of a filter head having a four-locking recess configuration and detailing the angle of rotation required to install a filter cartridge; and

FIG. 11b illustrates a bottom plan view of a filter head having a two-locking recess configuration and detailing the angle of rotation required to install a filter cartridge.

These and other features of the subject invention will become more readily apparent to those having ordinary skill in the art form the following detailed description of the preferred embodiments.

### DETAILED DESCRIPTION OF PREFERRED EMBODIMENTS

The present invention overcomes several of the problems associated with prior art filtration assemblies. The advantages, and other features of the filtration assembly and method of manufacturing the same disclosed herein, will become more readily apparent to those having ordinary skill in the art from the following detailed description of certain preferred embodiments taken in conjunction with the drawings which set forth representative embodiments of the present disclosure.

I. Method of Manufacture

As described in detail hereinbefore, filtration assemblies typically include, among other things, a filter head and a cartridge housing having filter media contained therein. The filter head is generally fixably installed within a fluid delivery system and includes both inlet and discharge ports which are in fluid communication with supply and discharge conduits. The filter cartridge is replaceable and is normally equipped with two radially projecting cam lugs which are configured for rotational engagement or disengagement with corresponding recesses or receptacles formed in the filter head.

Prior art filter heads which include engagement receptacles are manufactured primarily by an injection molding process. However, mechanical tooling is required to form or “blank out” the corresponding locking recesses or receptacles in the filter head. One prior art manufacturing process uses a collapsing core tooling configuration which includes radially projecting blades mounted to the centerpost which are disposed 180° apart from one another. The blades are used to create the undercut or envelope which forms the receptacles located on the underside of the filter head. After the molding process, the blades are retracted radially inward to facilitate removal of the blades and the ejection of the filter head. Alternatively, prior art molding equipment has been known to include a rotating core configuration in which a portion of the core or centerpost is hydraulically actuated to rotate the filter head 90°. This rotation allows the blades which form the receptacles to be axially withdrawn. Mechanical tooling of this type is often unreliable, requires frequent maintenance and is costly.

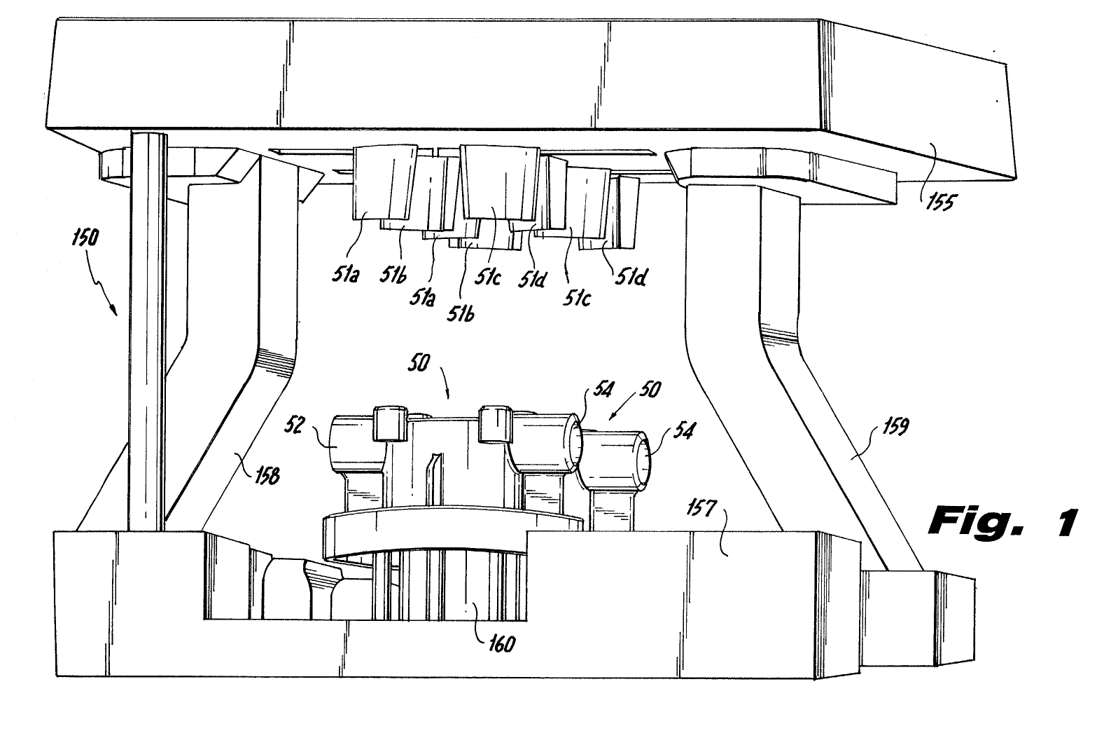

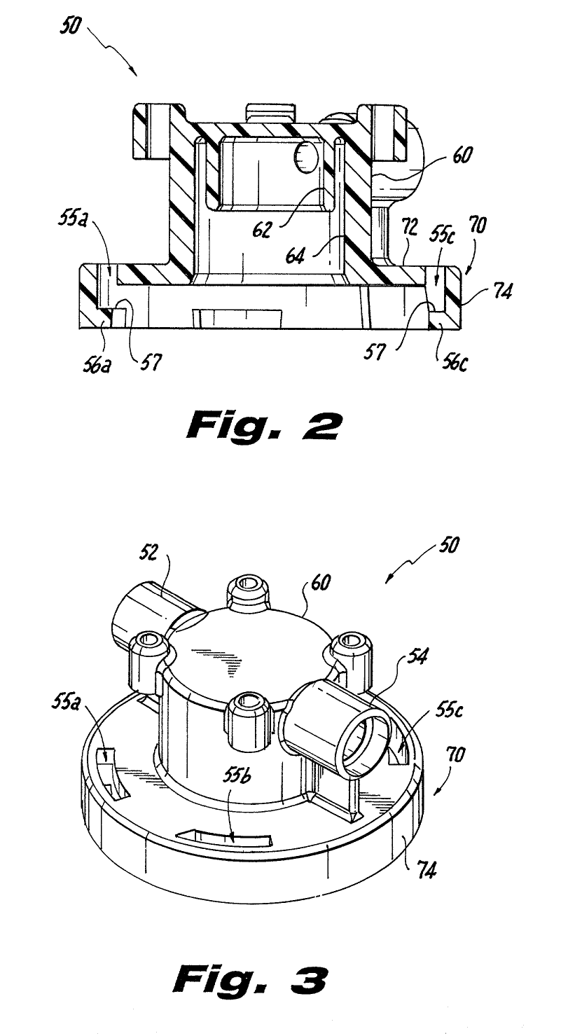

Referring to now to FIG. 1, there is illustrated an injection molding apparatus constructed in accordance with a preferred embodiment of the present disclosure and designated by reference numeral 150. A pair of filter heads 50 which have been manufactured using molding apparatus 150 are shown engaged therewith. Filter head 50 is a one-piece design, incorporating into a single filter head, a first inlet port 52 and a first outlet port 54, an upper sealing surface 62 (see FIG. 2), a lower sealing surface 64 (see FIG. 2) and engagement receptacle 56a-56d (see FIG. 2). Filter head 50 will be described in more detail with respect to FIGS. 2 through 4.

Filter head 50 is manufactured exclusively by injection molding apparatus 150, which does not include complex tooling. Molding apparatus 150 consists generally of upper and lower mold portions, 155 and 157, respectively and contoured guide bars. In the embodiment shown herein lower mold portion 157 includes first and second halves which are slid together so as to form the lower mold structure. Those skilled in the art will readily appreciate that the lower mold portion can be made from any number of mold parts or sections which are combined to form the compete lower mold. Upper mold portion 155 includes two sets of blades 51a-51d which are used to form or “blank off” the receptacle features of filter head 50. Lower mold portion 157 includes center mounting portion 160 which supports filter head 50 during the molding process and also forms the underside and central bore of filter head 50. The lower mold portion further includes two pairs of retracting or telescoping cylinders (not shown) which are used to form inlet port 52 and outlet port 54.

Referring now to FIGS. 2 through 4, which provide perspective and a cross-sectional views of filter head 50. Filter head 50 includes a head portion 60 and a base portion 70. The head and base portions 60 and 70 both define a central core 80 for filter head 50 which is adapted and configured for receiving a compatible filter cartridge housing. The base portion 70 has an upper web 72 and a lower flange 74 depending therefrom. As shown therein, access apertures 55a-55d are provided in web 72. Apertures 55a-55d are formed when blades 51a-51d, which are associated with upper mold portion 155, are inserted into the mold. The blades 51a-51d blank out the upper surface 57 of the ribs 56a-56d.

It is the incorporation of blades 51 a-51d into molding apparatus 150 that eliminates the need to use complex tooling to form of the locking recesses and the define the upper surface of ribs 56a-56d and allows the filter head 50 to be manufactured as a single piece, exclusively by injection molding. Therefore, a filter head configuration and method of making the same has been developed which eliminates the need for the use of complex tooling in the manufacturing process, allowing the part to formed exclusively by injection molding.

Those skilled in the art will readily appreciate that the quantity, size and arc length of the blades is related to the desired number of cam lugs and receptacles. Additionally, the inventive aspects described above can be applied to any filter head configuration which requires a series of receptacles in the base portion as long as the apertures are fluidly isolated from the fluid flow path through the filtration assembly.

II. Custom-Fit Feature

The filter heads and cartridge housings which are the subject of the present disclosure are also configured so that a common base mold can be used for an entire series, set or family of custom-fit filter assemblies. This is achieved by holding constant design attributes such as port locations, mounting hole locations and seal types. Maintaining continuity with respect to these features, enables a single base mold to be used for a family of custom-fit filter assemblies.

Then the custom-fit feature is created by inserting easily installed and removable mold inserts into the base mold. These mold inserts allow features such as the diameter of the upper and lower o-ring sealing surfaces, as well as the quantity, shape and size of the engagement lugs and the corresponding ribs/locking recesses therefor to be varied. It is variations in one or several of these features that create the custom-fit relationship and ensure filter cartridge compatibility with the filtration system.

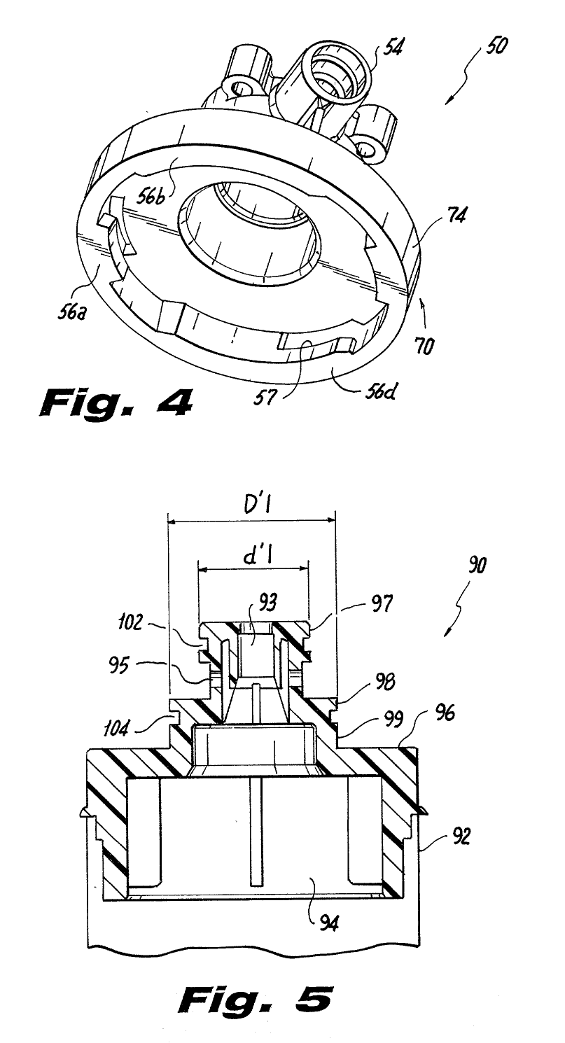

Referring now to FIG. 5 there is illustrated a filter cartridge housing constructed in accordance with a preferred embodiment of the present disclosure and designated by reference numeral 90. Filter cartridge housing 90 includes a generally cylindrical body portion 92 enclosing filter media 94 for filtering process fluid, an end cap 96 enclosing the body portion 92, and a cylindrical neck portion 98 depending from the end cap 96. The neck portion 98 of filter cartridge 90 is adapted and configured for reception with the central core 80 of filter head 50 and includes an upper section 97 and a lower portion 99.

The upper section 97 defines a radial inlet passage 95 for receiving unfiltered process fluid which has entered into head 50 through inlet port 52 and directing the fluid into the body portion 92 of filter cartridge 90. The upper section 97 further defines an axial outlet passage 93 for delivering conditioned process fluid from the interior of body portion 92 to the head member 50 for egress through the outlet port 54. The inlet and outlet passages 52 and 54 of head member 50 are sealingly isolated from one another by an upper O-ring seal which accommodated within annular recess 102 formed at the upper end of the neck portion 98. A second lower O-ring seal is accommodated within annular recess 104 formed below the radial inlet passage 95 to sealingly engage the neck portion 98 within the central core 80 of filter head 50 and prevent leakage of unfiltered process fluids from the filter assembly.

With continuing reference to FIG. 5 in conjunction with FIGS. 2 through 4, four circumferentially spaced apart cam lugs (not shown) project radially outwardly from cartridge housing 90. The cam lugs are dimensioned and configured to facilitate rotational engagement of the filter cartridge housing 90 within the locking recesses defined partially by ribs 56a-56d. As best seen in FIG. 2, a central core 80 is adapted and configured for receiving the neck portion 98 of filter cartridge housing 90. The ribs 56a-56d project radially into central core 80 for interacting with the cam lugs. The ribs 56a-56 are spaced from one another to allow the cam lugs to fit therebetween (the reception area of the engagement area) when the neck portion is extended into central core 80.

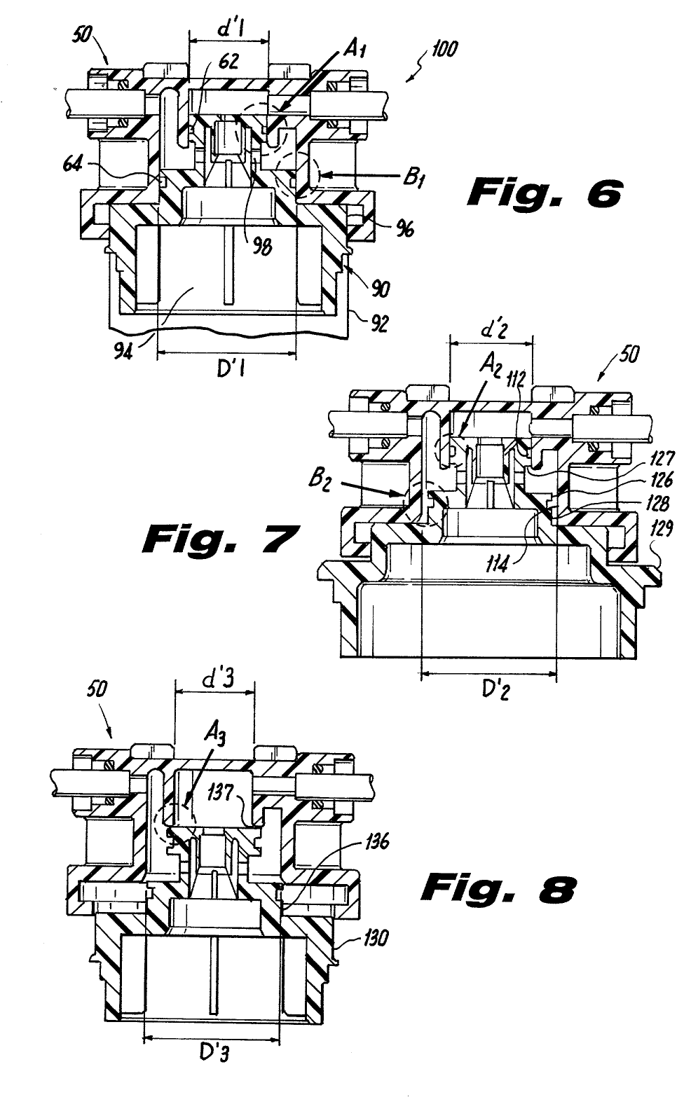

FIGS. 6 through 8 illustrate how variations in the diameter of either the upper or lower sections 97 and 99 of the neck portion 98 or the O-ring sealing surfaces can be used to create the custom-fit feature. In these figures d′ₓ and D′ₓ represent the diameters of the upper and lower sealing surfaces (x being a variable from 1 to 3 and depends on the figure being referred to). In FIG. 6, the upper and lower O-ring sealing surfaces, reference numerals 62 and 64 respectively, of filter head 50 have diameters which complement the corresponding upper and lower sections 97 and 99 of the neck portion 98 of filter cartridge housing 90. Therefore, cartridge housing 90 can be inserted into filter head 50 to engage the receptacles 56a-56d and a fluid tight seal is created in sealing areas A₁ and B₁. In FIG. 7, upper sealing surface 112 has a diameter d′₂ which compliments the corresponding diameter of the upper section 127 of the neck 126 of the filter cartridge housing 125, but the diameter D′2 of lower sealing surface 114 is larger than the diameter of the lower section 128 of the neck portion 126. As a result, the filter assembly will leak in sealing area B₂, indicating to the installer that filter cartridge 125 is not compatible with filter head 50. FIG. 8 illustrates a configuration in which the diameter of the upper sealing surface d′₃ does not correspond to the diameter of the upper section 137 of the neck portion 136. As a result, an interference exists in sealing area A₃ and the filter cartridge 110 can not be properly installed.

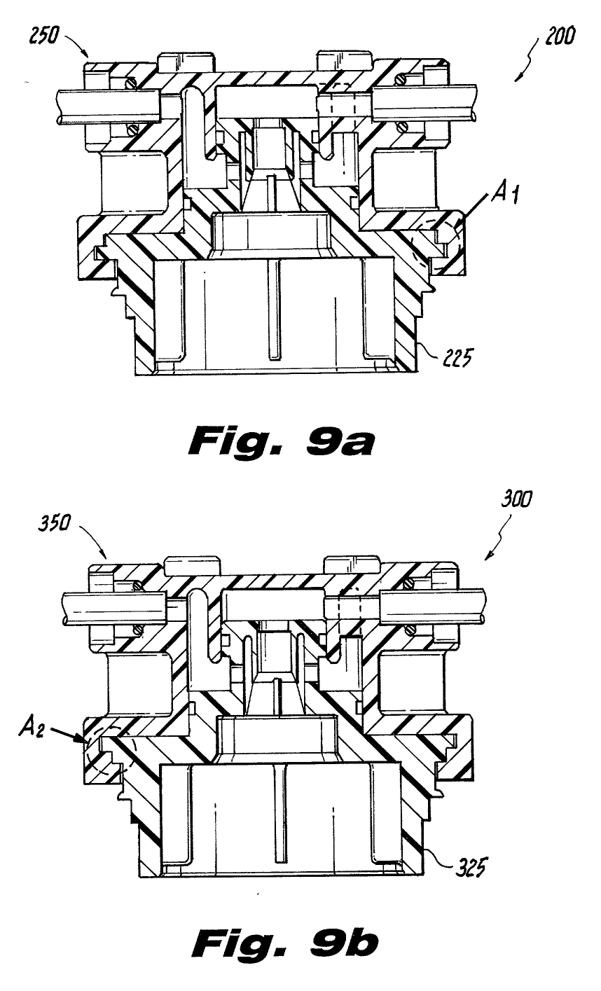

Additionally, the custom-fit feature can also be accomplished by varying the arrangement and shape of the lugs and ribs/locking recesses. For example, the location of the lugs and ribs can be reversed in that the lugs can be associated with the filter head and the corresponding ribs/recesses associated with the filter cartridge. FIGS. 9a and 9b illustrates two filtration assemblies 200 and 300, respectively, which have different shaped lugs and corresponding ribs (see areas “A₁” and “A₂” in FIGS. 9a and 9b respectively). Because of the shape of the lugs, filter cartridge housing 225 would not be compatible with head member 350. Similarly, filter cartridge housing 325 would not properly engage with head member 350.

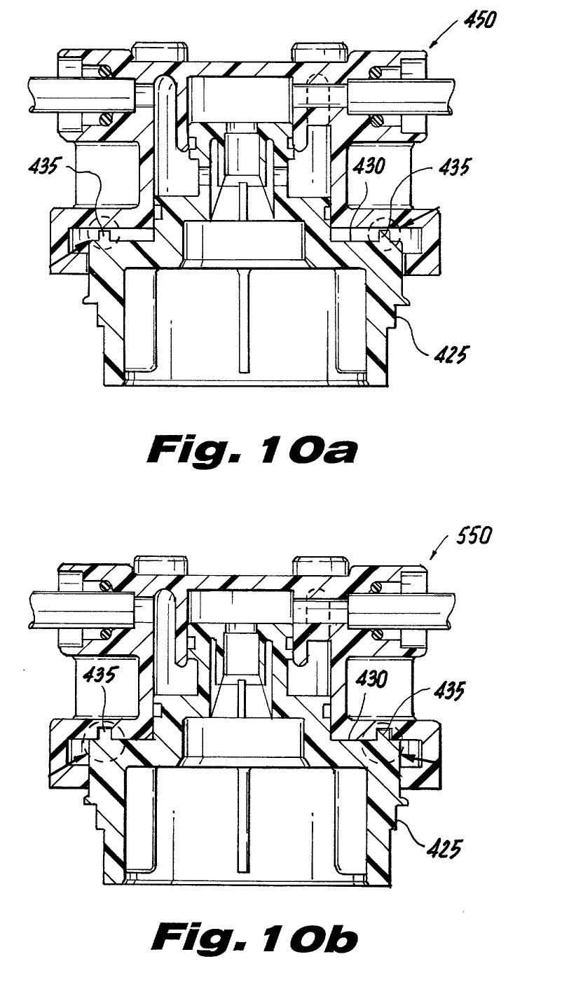

The custom-fit feature can also be accomplished by equipping the filter cartridge housing with a face key. FIGS. 10a and 10b illustrate a filter cartridge housing 425 equipped with a face key. As shown in these figures, the face key includes a set of angularly spaced projections, designated by reference numeral 435, that protrude from the top 430 of the filter cartridge housing 425 to mate with corresponding spaced apart recesses formed in the base of the filter head 550. As shown in FIG. 10a, unless a corresponding recess exists in filter head 450, an interference will exist, preventing the replacement cartridge housing 425 from being inserted. Variation in the placement, width, depth, shape or number of projections can be used to create numerous key sets. Alternatively, the key could be reversed so that the filter head contains the angularly spaced apart projection and the cartridge contains a corresponding recess.

Several other configuration changes can be used to create the custom-fit feature without complicating the manufacturing process. For example, the O-ring location and corresponding groove and wall sizes can be varied, the size, positioning and orientation of the connecting ports may be changed without significantly impacting the manufacturing cost.

III. Receptacle/Lug Configuration

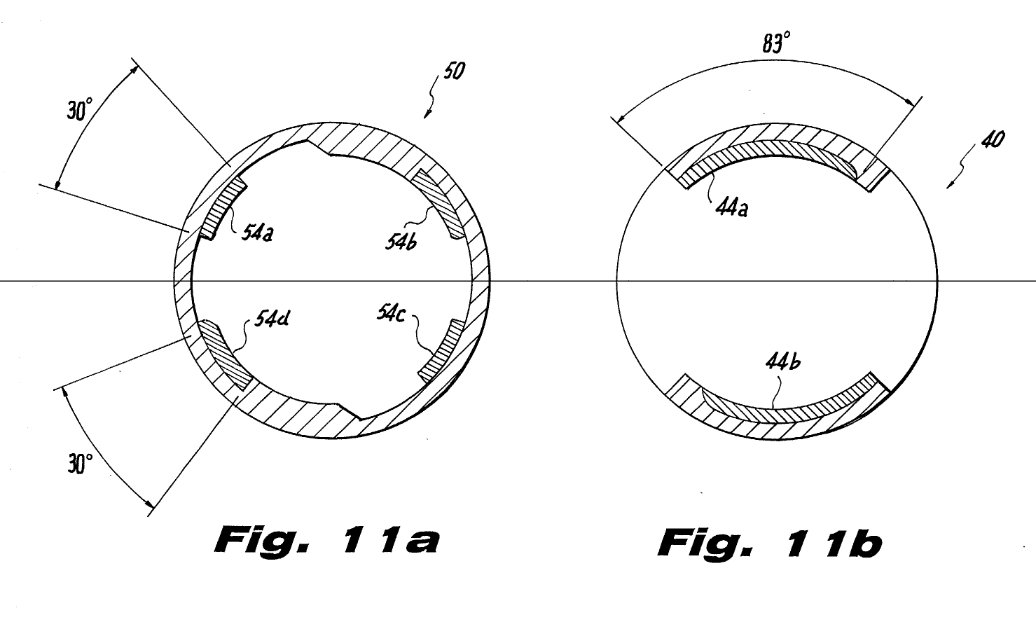

FIGS. 11a and 11b illustrate a four lug and a two lug filter head configuration, designated as reference numerals 50 and 40 respectively. As shown in FIG. 11b, in order to fully engage a filter cartridge to the base of the filter head 40 in a typical two lug configuration, the cartridge must be rotated over the angular length of the receptacles 44a and 44b, approximately 83°. Rotation of this magnitude can be a problem in installations in which limited access is available for removal and replacement of the filter cartridge. Reducing the angle of rotation required to install the replacement filter cartridge will facilitate the replacement process.

As discussed previously, FIGS. 11a and 11b illustrate the amount of rotation required to fully engage the lugs with the ribs/locking recesss for both a two lug 40 and four lug design 50. As shown therein, the two lug design 40 requires 83° of rotation in order to achieve full engagement. Since the four lug design utilizes lugs 54a-54d which are shorter in arc length, this configuration only requires 30° of rotation in order to fully engage the cartridge. Increasing the number of lugs to five or six lugs would further reduce the rotation required for complete engagement. Therefore, an improved filter assembly has been developed which utilizes at least three or more lugs and ribs for mounting the cartridge to the filter head.

In a preferred embodiment, the filter head is constructed from plastic which provides corrosion resistance, a surface finish that encourages sealing and repels contamination. However, other material are considered within the scope of this disclosure.

It should be noted that the details discussed herein are for illustrative purposes only and should not be construed to limit or restrict the scope of the subject disclosure. More specifically, while this disclosure has been described with respect to preferred embodiments, those skilled in the art will readily appreciate that various changes and/or modifications can be made thereto without departing from the spirit or scope of the subject invention as defined by the appended claims.

What is claimed is:

1. A filter head for use in a filtration assembly which includes a replaceable cartridge housing containing filter media for conditioning fluid passing therethrough, the cartridge housing having a neck portion and at least two angularly-spaced apart lugs projecting radially outwardly therefrom, the filter head comprising:
an upper body portion and a lower body portion, the upper body portion defining an axial bore for receiving the neck portion of the cartridge housing, the lower body portion including a radially extending web section and flange section depending axially from an outer periphery of the web section, an inner surface of the flange section defining at least two engagement areas, each engagement area including a reception area for axially receiving one of the cartridge housing lugs and a locking recess associated therewith and angularly offset therefrom for rotatably receiving the cartridge housing lug, a lower surface of each locking recess being defined by a rib structure which axially secures the cartridge housing to the filter head, the web section having apertures formed therein which are radially aligned with and extend over each rib structure;
each locking recess being formed by inserting downwardly projecting blades into a mold assembly which forms the filter head by injection molding.

2. A filter head as recited in claim 1, wherein each aperture formed in the web section of the upper body portion is arcuate.

3. A filter head as recited in claim 1, wherein the axial bore of the upper body portion defines first and second sealing surfaces.

4. A filter head as recited in claim 3, wherein the upper body portion of the filter head further includes at least one inlet port for receiving fluid into the filter head and at least one outlet port for discharging fluid from the filter head.

5. A filter head as recited in claim 4, wherein the first sealing surface acts to fluidly isolate the at least one inlet port of the upper body portion from the at least one outlet port and the second sealing surface fluidly isolates the at least one inlet port from each aperture formed in the web section of the lower body portion when the neck portion of the filter cartridge housing is received in the axial bore of the filter head.

6. A method of manufacturing a filter head which includes an upper body portion and a lower body portion, the upper body portion defining an axial bore, the lower body portion including a radially extending web section and flange section depending axially from an outer periphery of the web section, an inner surface of the flange section defining at least two engagement areas, each engagement area including a reception area for axially receiving one of the cartridge housing lugs and a locking recess associated therewith and angularly offset therefrom for rotatably receiving the cartridge housing lug, a lower surface of each locking recess being defined by a rib structure which secures the cartridge housing to the filter head, the web section having apertures formed therein which are radially aligned with and extend over each rib structure, comprising the steps of:
a) providing an upper base mold portion having a bottom surface which is adapted and configured for defining an upper section of the filter head, the bottom surface having at least two blade elements projecting downwardly therefrom;
b) providing a lower base mold portion having a top surface and a central post member, the top surface being adapted and configured for defining a lower section of the filter head, the center post being adapted and configured for defining the axial bore of the filter head; and
c) positioning the bottom surface of the upper base mold portion adjacent to the top surface of lower base mold portion so as to define a mold chamber therebetween, each blade element of the upper mold portion projecting into the mold chamber so as to define each aperture in the web section and each engagement area locking recess; and
d) filling the mold chamber with a thermoplastic by injection so as to form the filter head.

7. A method of manufacturing a filter head as recited in claim 6, further including the step of positioning a mold insert over the central post of the lower based mold prior to the step of positioning the bottom surface of the upper base mold portion adjacent to the top surface of lower base mold, the mold insert being adapted and configured for defining at least one inner surface of the axial bore.

8. A method of manufacturing a filter head as recited in claim 6, further including the step of positioning a ring-shaped mold insert adjacent to the top surface of the lower mold portion and concentrically around the central post, prior to the step of positioning the bottom surface of the upper base mold portion adjacent to the top surface of lower base mold, the mold insert having an upper surface which includes at least one protuberance so as to form a corresponding recess in the web section of the filter head.

9. A method of manufacturing a filter head as recited in claim 6, further including the step of positioning a ring-shaped mold insert adjacent to the top surface of the lower mold portion and concentrically around the central post, prior to the step of positioning the bottom surface of the upper base mold portion adjacent to the top surface of lower base mold, the mold insert having an outer surface which includes at least two protuberances, the outer surface being adapted and configured for defining the at least two reception areas of the flange section.

10. A set of interconnecting filter heads and cartridge housings comprising:
a) a plurality of filter cartridge housings, each housing including a body portion and a neck portion depending from and in fluid communication with the body portion, the neck portion defining an upper section with a first outer diameter and a lower section with a second outer diameter, wherein each housing in the set has at least one of a first outer diameter and a second outer diameter which differs from each of the other housings in the set; and
b) a plurality of filter heads each having an upper sealing surface with a first inner diameter and a lower sealing surface with a second inner diameter dimensioned to sealing correspond with the first and second outer diameters of only one of the plurality of filter cartridge housings in the set.

11. A set of interconnecting filter heads and cartridge housings as recited in claim 10, wherein the first outer diameter of the upper neck portion and the second outer diameter of the lower neck portion have a recess formed therein for receiving an O-ring seal.

12. A set of interconnecting filter heads and cartridge housings as recited in claim 10, wherein each filter head includes an upper body portion and a lower body portion, the upper body portion having the upper and the lower sealing surfaces associated therewith, the lower body portion including a radially extending web section and flange section depending from an outer periphery of the web section, the web section having at least two apertures formed therein.

13. A set of interconnecting filter heads and cartridge housings as recited in claim 12, wherein each cartridge housing further includes at least two lugs depending radially outwardly therefrom and the flange portion of the base has at least two engagement areas formed therein for receiving the lugs of the corresponding cartridge housing and securing the housing thereto.

14. A set of interconnecting filter heads and cartridge housings comprising:
a) a plurality of filter cartridge housings, each housing including a body portion and a neck portion depending from and in fluid communication with the body portion, the neck portion defining an upper section with a first outer diameter and a lower section with a second outer diameter, each housing having at least two lugs depending radially outwardly therefrom;
b) a plurality of filter heads each having an upper sealing surface with a first inner diameter and a lower sealing surface with a second inner diameter, each filter head having at least two engagement areas formed therein, the engagement areas being adapted and configured for receiving the lugs of the of the cartridge housing; and
c) means for ensuring that each filter head is compatible with only one of the plurality of filter cartridge housings in the set.

15. A set of interconnecting filter heads and cartridge housings as recited in claim 14, wherein the means for ensuring that each filter head is compatible with only one of the plurality of filter cartridge housings includes configuring the first inner diameter of the upper sealing surface so that it corresponds with the first outer diameter of only one of the plurality of cartridge housings in the set.

16. A set of interconnecting filter heads and cartridge housings as recited in claim 14, wherein the means for ensuring that each filter head is compatible with only one of the plurality of filter cartridge housings includes configuring the second inner diameter of the lower sealing surface so that it corresponds with the second outer diameter of only one of the plurality of cartridge housings in the set.

17. A set of interconnecting filter heads and cartridge housings as recited in claim 14, wherein the means for ensuring that each filter head is compatible with only one of the plurality of filter cartridge housings includes varying a quantity of the at least two engagement areas so as to correspond with a quantity of the at least two lugs of only one of the plurality of cartridge housings in the set.

18. A set of interconnecting filter heads and cartridge housings as recited in claim 14, wherein the means for ensuring that each filter head is compatible with only one of the plurality of filter cartridge housings includes varying the configuration of the at least two engagement areas so as to correspond with the at least two lugs of only one of the plurality of cartridge housings in the set.
